(19) United States
(12) Patent Application Publication
(10) Pub. No.: US 2014/0251895 A1
(43) Pub. Date: Sep. 11, 2014

(54) Filter, Filter Element, and Filter Housing

(71) Applicant: MANN + HUMMEL GMBH, Ludwigsburg (DE)

(72) Inventor: Fabian Wagner, Moeglingen (DE)

(73) Assignee: MANN + HUMMEL GMBH, Ludwigsburg (DE)

(21) Appl. No.: 14/198,808

(22) Filed: Mar. 6, 2014

(30) Foreign Application Priority Data
Mar. 6, 2013 (DE) 10 2013 003 753.0

(51) Int. Cl. F02M 35/024; F02M 37/22

(52) U.S. Cl. CPC F02M 35/02425; F02M 37/22
USPC 210/445; 210/483; 210/541

(57) ABSTRACT

A fluid filter has a filter housing with a first filter housing part that has an installation opening for an exchangeable filter element and is closeable with a second filter housing part. The first filter housing part has a first sealing surface and the second filter housing part has a second sealing surface interacting with the first sealing surface. The filter element has a seal circumferentially and radially extending relative to a filter axis. The seal is arranged between the first and second sealing surfaces when the filter element is correctly installed. The seal has a positioning contour in which a course of the seal at least in one section has an axial directional component relative to the filter axis. The first and second sealing surfaces each have an appropriate positioning counter contour which receive the at least one positioning contour when the filter element is correctly installed.

### CROSS-REFERENCE TO RELATED APPLICATION

This application claims the benefit of German patent application no. 10 2013 003 753.0 filed Mar. 6, 2013, the entire contents of the aforesaid German patent application being incorporated herein by reference.

### BACKGROUND OF THE INVENTION

The invention concerns a filter for fluid, in particular air, oil, water, fuel or urea solution, in particular of an internal combustion engine, in particular of a motor vehicle.

Moreover, the invention concerns a filter element of a filter for fluid, in particular air, oil, water, fuel or urea solution, in particular of an internal combustion engine, in particular of a motor vehicle.

Moreover, the invention concerns a filter housing of a filter for fluid, in particular air, oil, water, fuel or urea solution, in particular of an internal combustion engine, in particular of a motor vehicle.

An air filter of an internal combustion engine of a motor vehicle that is known on the market has a filter housing in which an exchangeable filter element is arranged.

The invention has the object to configure a filter, a filter element, and a filter housing of a filter of the aforementioned kind with which an operationally safe positioning of the filter element in the filter housing is improved.

### SUMMARY OF THE INVENTION

This object is solved according to the invention by an openable filter housing, comprising a first filter housing part provided with an installation opening for an exchangeable filter element that can be closed off by a second filter housing part, wherein the first filter housing part comprises a first sealing surface and the second filter housing part comprises a second sealing surface interacting with the first sealing surface, and wherein the filter element comprises a seal that extends circumferentially relative to a filter axis and extends radially, which, when the filter element is correctly installed in the filter housing, viewed axially relative to the filter axis, is arranged between the first sealing surface and the second sealing surface, and the seal comprises at least one positioning contour in which a course of the seal at least in one section has an axial directional component relative to the filter axis, and the first sealing surface and the second sealing surface each comprise a matching positioning counter contour that, when the filter element is correctly installed, receive the at least one positioning contour.

According to the invention, the seal comprises thus at least one positioning contour which disturbs a possible symmetry of geometries of the filter element interacting with the filter housing. In this way, it can be achieved that the filter element can be installed only in predetermined installation positions, preferably only in a single predetermined installation position, in the filter housing in which the at least one positioning contour in orientation and position coincides with the two corresponding positioning counter contours of the filter housing. Moreover, it can be achieved in this way that the faulty installation of a filter element which does not have the matching at least one positioning contour can be recognized, preferably prevented, early on. In this way, as a whole, the operational safety of the filter is increased. In particular when using the filter as an air filter of an internal combustion engine, it may be required to be able to position the filter element reproducibly and precisely in the filter housing in order to be able to realize with an appropriate sensor, in particular a hot film air mass meter (HFM) a reproducible operating parameter, in particular an air-mass flow signal.

With the at least one positioning contour with an axial directional component, it is possible to reduce needed space radial to the filter axis.

The filter can be an air filter or a cabin filter of a motor vehicle. A different kind of filter, in particular for air, oil, water, fuel or urea solution, can be used also.

The filter element can be a filter element with a flat fold bellows and/or a filter element with a fold bellows that has folds of different height. For example, the filter element can also be embodied as a coiled or layered compact air filter element. In particular, the compact air filter element is constructed of at least one flat and one corrugated filter media layer which form alternatingly closed fluid passages.

Preferably, the filter element comprises a circumferentially extending plastic frame which is, for example, injection-molded onto the filter medium. The plastic frame serves as a support of the circumferentially extending seal. For this purpose, the seal can be injection-molded or joined to the plastic frame. In case of a filter element with a fold bellows, the plastic frame serves additionally for lateral sealing of the fold pockets, for example.

The first filter housing part and/or the second filter housing part can be of a single-part or multi-part configuration. The filter housing can advantageously be closed or opened by means of a linear movement and/or a pivot movement of the filter housing parts relative to each other. The filter housing parts can be separated completely from each other for opening the filter housing. Alternatively, the filter housing parts can be attached to each other by means of a flexible connection so that they can remain connected to each other captively even when the filter housing is open. The filter housing can also be combined of more than two filter housing parts so as to be openable.

The first filter housing part can comprise a first connecting flange at a free rim surrounding the installation opening that is extending circumferentially relative to the filter axis. The first connecting flange can comprise the first sealing surface. The second filter housing part can be provided with a second connecting flange at a corresponding free rim that is circumferentially extending relative to the filter axis. The second connecting flange can comprise the second sealing surface. The first connecting flange and/or the second connecting flange can extend advantageously on the filter housing in radial direction outwardly.

Advantageously, the filter element can be a flat filter element. The flat filter element can be planar or curved. Alternatively, the filter element can also be realized in a different way, in particular as a round filter element, oval round filter element or conical round filter element. The filter element can comprise a filter medium that is folded in a zigzag shape to a filter bellows. Alternatively, the filter bellows can also comprise a filter medium that is not folded. In case of a flat filter element, the filter bellows can have approximately the form of a parallelepiped. In case of flat filter elements, the filter media are not closed, i.e., in case of folded filter bellows the end face folds as well as the end face edges are not connected to each other. In contrast thereto, in case of round filter elements the filter media are closed, i.e., their end face folds are connected to each other. The filter axis of the flat filter element can advantageously extend perpendicular to an inflow side and/or outflow side of the filter medium. The inflow side and the outflow side in case of a folded filter medium can each be spanned by the appropriate fold edges.

In an advantageous embodiment, the seal can extend along a plane outside of the at least one positioning contour, and the first sealing surface and the second sealing surface can extend along a plane outside of the respective at least one positioning counter contour, respectively. In this way, the axial space demand of the seal as a whole can be reduced. Moreover, planar sealing surfaces and seals as a whole can be realized more easily.

In a further advantageous embodiment, the seal can act axially relative to the filter axis. The filter element can be mounted advantageously through the installation opening in the filter housing part so that the seal will rest flat on the first sealing surface. Subsequently, the second filter housing part can be mounted on the first filter housing part so that the second sealing surface presses the seal in axial direction against the first sealing surface. A pressing force acting in this context can be generated by appropriate fastening means, in particular screws or clamps which connect the first housing part with the second housing part.

Advantageously, the seal can also act, additionally or alternatively, radially relative to the filter axis.

In a further advantageous embodiment, the seal can have a stabilization core. With the stabilization core the shape of the seal can be predetermined or stabilized.

The stabilization core can advantageously be made of plastic material. Plastic material can easily be formed also in complex shape. In this way, also different shapes can be realized in a simple way. Also, by means of plastic material, the weight of the stabilization core can be kept appropriately low. With the stabilization core one can moreover prevent that, in case of a wrong installation of the filter element, the positioning contour can be compressed or even destroyed by correspondingly increased force action upon compression of the two sealing surfaces. In this way, the installation safety can be further improved.

The seal can be advantageously made of an elastic material, in particular plastic material. Accordingly, the seal can adapt tightly to the sealing surfaces. Elastic sealing material can also be compressed simply between the two sealing surfaces so that the sealing action is improved. The sealing material can also be injection-molded onto the stabilization core. The stabilization core can be embedded by injection molding in the sealing material. The seal can be monolithic. It can embed the stabilization core completely. Alternatively, the seal can also be of a multi-part configuration. A multi-part seal can cover appropriate sides of the stabilization core.

In a further advantageous embodiment, the seal can project radially relative to the filter axis past a filter medium of the filter element. In this way, the sealing contact between the seal and the sealing surfaces can be realized radially outside of the filter medium. The seal can thus be realized without overlap with the filter surface of the filter medium.

Advantageously, alternatively or additionally, the seal can project past the filter medium in axial direction.

In a further advantageous embodiment the filter element can have a frame. With the frame, the shape of a filter medium of the filter element can be predetermined and stabilized. Moreover, the frame can perform a holding function so that the filter medium, in particular a filter medium bellows, is secured stably in the filter housing. Advantageously, the frame can extend circumferentially relative to the filter axis. Moreover, advantageously the frame can be closed circumferentially. The frame can advantageously be made of plastic material.

Advantageously, the seal can be indirectly or directly attached to the frame in a simple way. The sealing material can advantageously be injection-molded indirectly or directly onto the frame. A possible stabilization core can be connected simply with the frame. In this way, the mechanical stability of the filter element can be further improved. Advantageously, the possible stabilization core can be connected monolithically with the frame.

In a further advantageous embodiment, the at least one positioning contour can be realized as a kink or bend of the seal. By means of a kink or a bend, in a simple way a possible symmetry of the seal can be interrupted. In this way, a unique installation position of the filter element in the filter housing can be defined easily.

In a further advantageous embodiment, several positioning contours can be provided along the circumferential length of the seal. In this way, the installation precision can be further improved. Advantageously, the positioning contours can be arranged unsymmetrically along the seal, in particular relative to the filter axis.

In a further advantageous embodiment, the at least one positioning contour and the respective positioning counter contours can be matched to each other in form and/or dimension such that in case of wrong installation of the filter element the at least one positioning contour prevents a correct assembly of the first filter housing part and the second filter housing part. Accordingly, already upon assembly of the filter housing it can be recognized in a simple way that the filter element is installed in the wrong way or a wrong filter element has been employed. In this way, the operational safety of the filter can be further improved.

The technical object is further solved by the filter element according to the invention that has a seal that extends circumferentially relative to a filter axis and extends radially and comprises at least one positioning contour in which the course of the seal at least in one section has an axial directional component relative to the filter axis. The advantages and features that have been discussed above in connection with the filter according to the invention and its advantageous embodiments apply likewise to the filter element according to the invention, and vice versa.

The technical object is furthermore solved by the openable filter housing according to the invention, comprising a first filter housing part that comprises an installation opening for an exchangeable filter element that can be closed with a second filter housing part, wherein the first filter housing part comprises a first sealing surface and the second filter housing part comprises a second sealing surface interacting with the first sealing surface and wherein the first sealing surface and the second sealing surface each have a positioning counter contour wherein a course of the first sealing surface and of the second sealing surface has at least in one section an axial directional component relative to the filter axis. The advantages and features that have been explained above in connection with the filter according to the invention and the filter element according to the invention apply likewise to the filter housing according to the invention, and vice versa.

### BRIEF DESCRIPTION OF THE DRAWINGS

Further advantages, features, and details of the invention result from the following description in which an embodiment of the invention will be explained in more detail with the aid of the drawing. A person of skill in the art will consider the features disclosed in the drawing, the description, and the claims in combination expediently also individually and will combine them to meaningful further combinations.

FIG. 1 shows an air filter of an internal combustion engine of a motor vehicle with a two-part air filter housing in which an exchangeable filter element is arranged;

FIG. 2 shows in an isometric illustration the filter element of FIG. 1;

FIG. 3 is a plan view of the filter element of FIGS. 1 and 2;

FIG. 4 is a view of the long side of the filter element of FIGS. 1 to 3; and

FIG. 5 is a cross-section of the air filter of FIG. 1.

In the Figures, same components are provided with same reference characters.

### PREFERRED EMBODIMENTS OF THE INVENTION

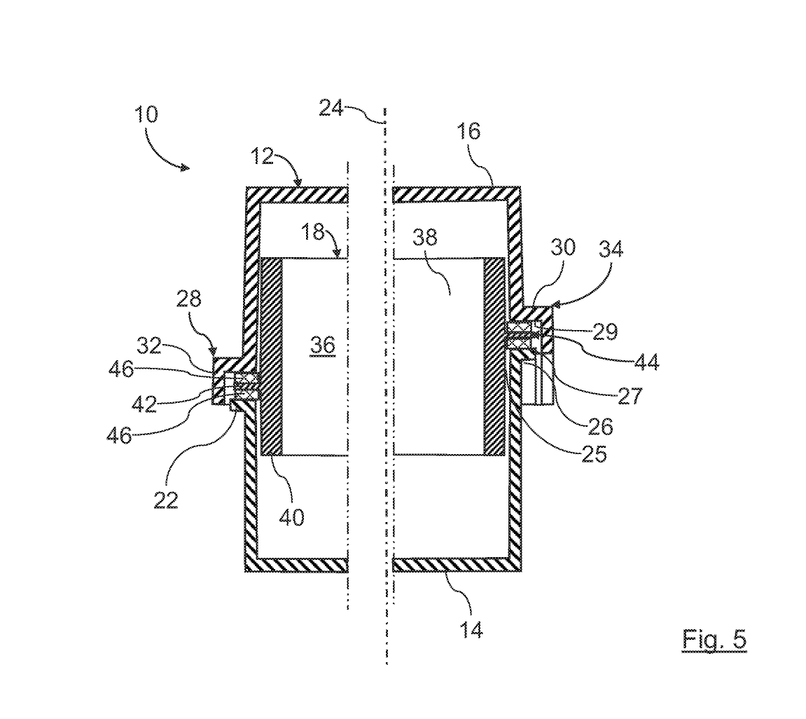

In FIG. 1, an air filter 10 of an internal combustion engine of a motor vehicle is shown. FIG. 5 shows the air filter 10 in cross-section. The air filter 10 is arranged in an intake air manifold, not shown in detail, of the internal combustion engine. It serves for filtration of the combustion air which is supplied to the internal combustion engine.

The air filter 10 comprises a filter housing 12 which is combined of a lower filter housing part 14 and an upper filter housing part 16. It is of no consequence for the invention how the air filter 10 is oriented in space. For example, the lower filter housing part 14 can also be arranged spatially above and the upper filter housing part 16 below. The lower filter housing part 14 and the upper filter housing part 16 are each approximately parallelepipedal.

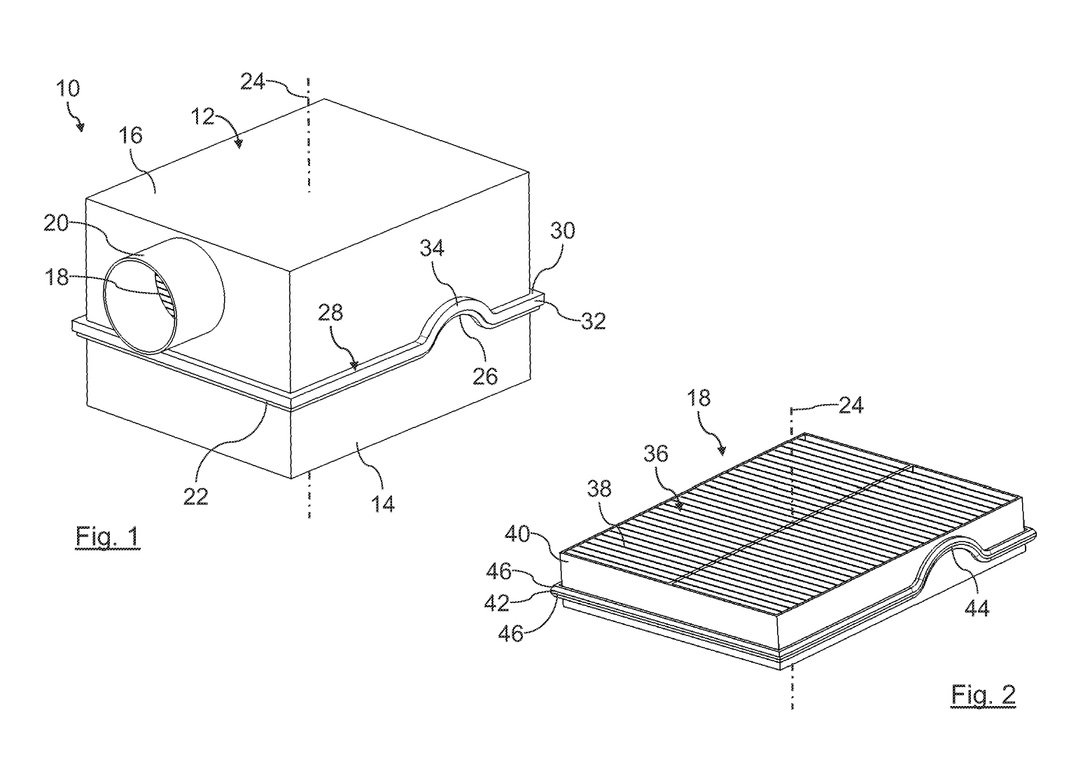

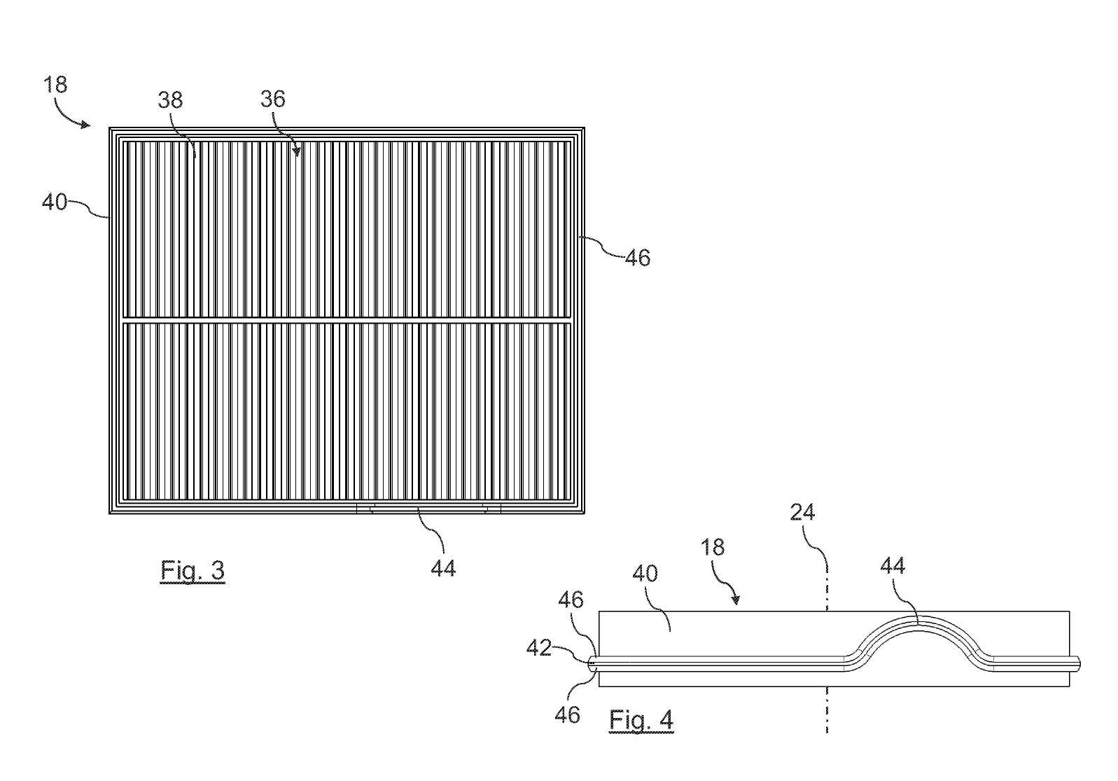

In the filter housing 12, a filter element 18 is arranged such that it seal-tightly separates an air inlet 20 for the combustion air to be purified, which is located in the upper filter housing part 16, from an air outlet for the purified combustion air, which is located in the lower filter housing part 14. The air outlet is hidden in FIG. 1 and therefore not shown. The filter element 18 is shown in FIGS. 2 to 4 in detail in different perspectives. The air filter 10 can also be flowed through in reverse direction by the internal combustion air.

The lower filter housing part 14 has a lower connecting flange 22 at its free rim which is facing the upper filter housing part 16. The lower connecting flange 22 extends relative to an imaginary filter axis 24 circumferentially closed and in radial direction outwardly away from the sidewalls of the lower housing part 14. When in the following “axial”, “radial” or “circumferential” is used, this relates to the filter axis 24, if nothing to the contrary is mentioned.

The lower connecting flange 22 surrounds an installation opening 25, shown in FIG. 5, of the lower housing part 14 through which the filter element 18 can be inserted into the lower housing part 14 when the upper filter housing part 16 is removed. The installation opening 25 is closed off, with filter housing 12 closed, by the upper filter housing part 16. When the air filter 10 is correctly mounted, approximately one third of the axial extension of the filter element 18 is located in the lower filter housing part 14. Approximately two thirds of the axial extension of the filter element 18 is located in the upper filter housing part 16.

A lower sealing surface 26 of the lower connecting flange 22 which is facing the upper filter housing part 16 extends substantially along a plane circumferentially and radially relative to the filter axis 24.

On a long side, the lower connecting flange 22 has a lower positioning counter contour 26. The lower positioning counter contour 26 is realized in the form of a bend which, viewed in axial direction from the upper filter housing part 16, is convex, i.e., has an axial directional component. The lower positioning counter contour 26 forms a projection which, relative to the plane in which the rest of the lower sealing surface 27 is located, is projecting toward the upper filter housing part 16.

The upper filter housing part 16 has at its free rim which is facing the lower filter housing part 14 a connecting flange 28 which corresponds to the lower connecting flange 22. The upper connecting flange 28 extends also circumferentially closed and in radial direction outwardly. A side of the radially and circumferentially extending section 30 of the upper connecting flange 28 which is facing the lower connecting flange 22 forms an upper sealing surface 29. The upper sealing surface 29 extends parallel to the lower sealing surface 27 circumferentially and in radial direction. It extends substantially along a corresponding plane, which is parallel to the plane along which the lower sealing surface 27 is extending.

Radially outwardly, the radial section 30 passes into a frame section 32 which extends axially toward the lower filter housing part 14. The frame section 32 surrounds the lower connecting flange 22 radially in outward direction. The lower connecting flange 22 is enclosed, positioned, and secured in lateral direction by the frame section 32.

On a long side, the upper connecting flange 28 has an upper positioning counter contour 34 which matches in shape and position the lower positioning counter contour 26. The lower positioning counter contour 26 engages the upper positioning counter contour 34 when the filter housing 12 is correctly closed. By interaction of the positioning counter contours 26 and 34 it can be prevented that the upper filter housing part 16 can be mounted in a wrong orientation on the lower filter housing part 14.

The filter element 18 is realized as a flat filter element. It has a filter medium bellows 36 that, as a whole, is approximately parallelepipedal of zigzag-shaped folded filter medium 38. The filter medium bellows 36 is framed by a circumferentially closed frame 40 of plastic material. A stabilization core 42 is monolithically disposed in the form of a web, which is circumferentially closed and extends in radial direction outwardly, on the radial outer circumferential side of the frame 40.

The stabilization core 42 has on its long side a bend for forming a positioning contour 44. The extension of the positioning contour 44 and its position with installed filter element 18 corresponds to the respective course and position of the lower positioning counter contour 26 and the upper positioning counter contour 34.

An elastic sealing material for realizing a two-part seal 46 is injection-molded, respectively, onto the upper and lower sides of the stabilization core 42 extending in radial direction. The seal 46 extends along the stabilization core 42 circumferentially and from the radial outer circumferential side of the frame 40 in radial direction outwardly. The seal 46 comprises also the positioning contour 44.

When the filter element 18 is correctly mounted, the stabilization core 42 with the seal 46 is positioned between the lower sealing surface 27 and the upper sealing surface 29. The seal 46 is compressed seal-tightly between the sealing surfaces 27 and 29 in axial direction. It acts thus axially. The positioning contour 44 in this context is received between the lower positioning counter contour 26 and the upper positioning counter contour 34. The asymmetric arrangement of the lower positioning counter contour 26 and of the upper positioning counter contour 34 on the filter housing 12 and the positioning contour 44 on the filter element 18 ensure that the filter element 18 can be installed only in the correct installation position into the filter housing 12. Should accidentally the filter element 18 be inserted upside down or rotated relative to the filter axis 24 into the lower filter housing 14, the positioning contour 44 and the positioning counter contours 26 and 34 prevent that the lower filter housing part 14 and the upper filter housing part 16 can be correctly assembled. The filter housing 12 can then not be closed. Also, the filter housing 12 cannot be closed if the inserted filter element does not have the correct positioning contour 44. In this way, it can be prevented that a filter element is used that does not match the filter housing 12.

In an alternative embodiment, not illustrated, in addition to the positioning counter contours 26 and 34 and the positioning contour 44 at least one further pair of positioning contours and positioning counter contours can be provided. The further contour pairs can be, for example, arranged on the opposite long side or one of the transverse sides of the filter element 18 and of the connecting flanges 22 and 28.

In the above-described embodiment of a filter 10, a filter housing 12, and a filter element 18, inter alia the following modifications are possible.

The invention is not limited to air filters of internal combustion engines of motor vehicles. Instead, it can also be used for other types of filters for fluids, for example, oil, water, fuel or urea solution. It can also be used outside of automotive technology, for example, in industrial motors. In the field of automotive technology, the invention can be used also outside of internal combustion engines, for example, as a cabin filter.

The lower filter housing part 14 and the upper filter housing part 16, instead of being parallelepipedal, can also be shaped differently.

The filter medium bellows 36, instead of being a zigzag-shaped folded filter medium 38, can also be of a different kind of filter medium, for example, flat and not folded.

While specific embodiments of the invention have been shown and described in detail to illustrate the inventive principles, it will be understood that the invention may be embodied otherwise without departing from such principles.

What is claimed is:

1. A filter for a fluid, the filter comprising:
an openable filter housing comprising a first filter housing part and a second filter housing part, wherein the first filter housing part has an installation opening and is closed off by the second filter housing part;
an exchangeable filter element disposed in the filter housing and inserted through the installation opening into the first filter housing part;
wherein the first filter housing part has a first sealing surface and the second filter housing part has a second sealing surface interacting with the first sealing surface;
a seal that extends relative to a filter axis of the filter circumferentially and radially and, viewed axially relative to the filter axis, is positioned between the first sealing surface and the second sealing surface when the filter element is correctly installed in the filter housing;
wherein the seal comprises at least one positioning contour in which a course of the seal has at least in one section an axial directional component relative to the filter axis;
wherein the first sealing surface and the second sealing surface each comprise a positioning counter contour receiving the at least one positioning contour of the seal when the filter element is correctly installed.

2. The filter according to claim 1, wherein the seal extends along a plane outside of the at least one positioning contour, and the first sealing surface and the second sealing surface extend along a plane outside of the respective at least one positioning counter contour.

3. The filter according to claim 1, wherein the seal acts axially relative to the filter axis.

4. The filter according to claim 1, wherein the seal has a stabilization core.

5. The filter according to claim 1, wherein the seal projects past a filter medium of the filter element in a radial direction relative to the filter axis.

6. The filter according to claim 1, wherein the filter element comprises a frame.

7. The filter according to claim 1, wherein the at least one positioning contour of the seal is a kink or a bend.

8. The filter according to claim 1, wherein the seal has several of the at least one positioning contour along a circumferential length of the seal.

9. The filter according to claim 1, wherein the at least one positioning contour and the positioning counter contours are matched to each other in shape and/or dimension such that, when the filter element is wrongly installed, the at least one positioning contour prevents correct assembly of the first filter housing part and the second filter housing part.

10. A filter element for a filter according to claim 1, the filter element comprising a seal extending relative to a filter axis of the filter circumferentially and radially, wherein the seal comprises at least one positioning contour in which a course of the seal at least in one section has an axial directional component relative to the filter axis.

11. A filter housing for a filter according to claim 1, the filter housing comprising:
a first filter housing part and a second filter housing part, wherein the first filter housing part has an installation opening for an exchangeable filter element and is closed off by the second filter housing part;
wherein the first filter housing part has a first sealing surface and the second filter housing part has a second sealing surface interacting with the first sealing surface;
wherein the first sealing surface and the second sealing surface each comprise a positioning counter contour in which a course of the first sealing surface or the second sealing surface has at least in one section an axial directional component relative to the filter axis.
